(19) United States
(12) Patent Application Publication
(10) Pub. No.: US 2006/0217506 A1
(43) Pub. Date: Sep. 28, 2006

(54) Liquid composition polymerizable into organic glass having good optical and physico-mechanical characteristics

(76) Inventors: Fiorenzo Renzi, Ravenna (IT); Willem Bos, Arnhem (NL); Simon Postmus, Duiven (NL); Roberto Forestieri, Ravenna (IT)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/552,368

(22) PCT Filed: Apr. 6, 2004
(86) PCT No.: PCT/EP04/03673

§ 371 Date: Oct. 7, 2005

(30) Foreign Application Priority Data
Apr. 11, 2003 (IT) MI2003A000758

(51) Int. Cl. C08F 4/28

(52) U.S. Cl. 526/227; 526/319

(57) ABSTRACT

A liquid composition is described, which can undergo radicalic polymerization into organic glass, comprising: 1) the product obtained from the transesterification of diallyl carbonate (A) with a blend of one or more linear or branched aliphatic diols (B), containing from three to ten carbon atoms in the molecule, with a linear or branched aliphatic polyol (C), containing from four to twenty carbon atoms and from three to six hydroxyl groups in the molecule, in an overall concentration ranging from 70 to 100% by weight with respect to the total weight of the mixture of components 1) and 2); 2) one or more comonomers of the acrylic, methacrylic, vinylic or allylic type and mixtures thereof, in an overall concentration ranging from 0 to 30% by weight with respect to the total weight of the mixture of components 1) and 2); 3) a polymerization initiator or a mixture of two or more polymerization initiators, stable at room temperature, belonging to the group of peroxides, in an overall concentration ranging from 0.03 to 0.1 moles per 1 kg of final composition

The present invention relates to a liquid composition polymerizable into organic glass having good optical and physico-mechanical properties.

More specifically, the present invention relates to a liquid composition which can undergo radicalic polymerization into organic glass having good optical and physico-mechanical properties, comprising the product obtained from the transesterification of diallyl carbonate (A) with a blend of one or more diols (B) with a polyol (C), in the presence of peroxide initiators stable at room temperature and, possibly, of one or more reactive co-monomers.

A further object of the present invention relates to the organic glass obtained from the polymerization of said composition.

Finally, another object of the present invention relates to the manufactured products obtained starting from said composition, such as, for example, ophthalmic lenses and solar filters, protective shields, display windows, manifolds and solar and photovoltaic panels, substrates for optical disks, display panels and video-terminals.

In the field of organic glass having a high transparency, the organic glass obtained from the polymerization of diethylene glycol bis(allyl carbonate) is of considerable commercial interest in the production of sheets and ophthalmic and safety lenses, thanks to their specific mechanical properties and aging resistance, as described, for example, by F. Strain in “Encyclopedia of Chemical Processing and Design”, First Edition, Dekker Inc., New York, Vol. 11, page 452 and subsequent pages; and in “Encyclopedia of Polymer Science and Technology” (1964), Vol. 1, page 799 onwards, Interscience Publishers, New York.

The use of diethylene glycol bis(allyl carbonate) however, has various drawbacks which make the manufacturing process of the end products based on this composition both risky from the point of view of safety and also economically onerous.

The polymerization reaction of the monomer under examination is, in fact, normally carried out in the presence of peroxide initiators belonging to the family of dialkyl-peroxy dicarbonates, such as, for example, diiso-propyl-peroxy dicarbonate (IPP) or mixtures of IPP and di-s-butyl-peroxy dicarbonate, which allow manufactured products having excellent optical properties, in particular transparency, and a low colouring, to be obtained.

These peroxides, however, have the disadvantage of being extremely costly and thermally very instable, with explosive decomposition, and thus require very severe transportation and storage conditions: peroxides must in fact be maintained at a temperature of around −20° C.

These peroxides are also commercially available diluted in the monomer, in varying concentrations. Although this solution allows the above-mentioned risks associated with thermal instability, to be partly reduced, it does not solve the problem of having to transport and stock the peroxides at unfavorable temperatures which, in the best of cases, with a mix containing only 10% of peroxide in the monomer, are equal to −15° C. and −10° C., respectively. This solution, moreover, has the disadvantage of considerably increasing the amount of initiator to be stored and handled daily, as well as the operating costs.

In order to overcome the above-mentioned drawbacks, it would be desirable to avail of peroxides which are stable at room temperature, possibly in the pure state or in concentrated form.

Peroxides having the above requirements are commercially available but generally they cannot be practically applied as polymerization initiators of diethylene glycol bis(allyl carbonate) for several reasons.

For example, in the group of diacyl peroxides, didecanoyl peroxide and dilauroyl peroxide have a favourable storage temperature (<30° C.), but a very poor solubility of the monomer, and cannot therefore be used as polymerization initiators of diethylene glycol bis(allyl carbonate).

Dibenzoyl peroxide has a much higher solubility with respect to the previous peroxides, but has other drawbacks. Even if it was, in fact, one of the first radicalic initiators proposed for this application, it has a very limited use due to the considerable yellowing of the lenses during polymerization and poor resistance to UV light. Lenses produced starting from diethylene glycol bis(allyl carbonate) with the use of dibenzoyl peroxide as polymerization initiator, tend to significantly turn yellow even after short exposure to solar light. The addition of light stabilizing additives allows the UV stability to be significantly improved but does not solve, but rather worsens, the problem of lens yellowing during polymerization.

Other peroxides stable at room temperature belong to the group of alkyl peresters, such as, for example, t-butyl-peroxy-3,3,5-trimethyl hexanoate, t-butyl-peroxy-2-ethyl-hexyl-carbonate and t-butyl-peroxy benzoate. They have the advantage of being liquid and easily mixable with diethylene glycol bis(allyl carbonate), but are not suitable as polymerization initiators as their decomposition temperatures are too high (>100° C.) and, above all, do not have an optimal efficiency, as they produce lenses not completely cross-linked and with a low hardness.

Finally, peroxy-dicarbonates such as di(4-t-butyl-cyclohexyl)-peroxy-dicarbonate and dimyristyl-peroxy-dicarbonate, which could be potentially of great interest as they have a reactivity very similar to that of IPP, have the disadvantage of being poorly soluble in the monomer and, due to their comparatively low percentage of active oxygen (Active Oxygen Content “AOC”) equal to 3.8% and 2.9%, respectively, against 7.7% of IPP, high concentrations of peroxide would be necessary for reaching physico-mechanical properties suitable for use in the optical field.

In order to overcome the above drawbacks, experts in the field would be tempted to experiment polymerizable compositions containing reduced amounts of stable peroxides at room temperature chosen from those mentioned above, which could have a solubility in the monomer within the limits of diethylene glycol bis(allyl carbonate) and/or improve the colour of organic glass and/or its resistance to UV radiations.

The above option, however, is not feasible, as the organic glass obtained from the polymerization of diethylene glycol bis(allyl carbonate) in the presence of small amounts of peroxides stable at room temperature normally have poor physico-mechanical properties, in particular a low hardness, a low glass transition temperature and poor abrasion resistance and resistance to chemical products.

In order to obviate this, and consequently make it possible to operate with reduced amounts of peroxide, experts in the field could choose to reduce the density of the polymerizable double bonds present in the composition, for example by effecting a pre-polymerization of the diethylene glycol bis(allyl carbonate) monomer until a viscosity 6-7 times higher is obtained.

In this way, having reduced the number of double bonds which take part in the polymerization reaction, an analogous reduction in the amount of peroxide required is expected. This solution allows an improvement in the properties of the organic glass produced with reduced quantities of stable peroxide at room temperature but, as the following experimental examples will demonstrate, the physico-mechanical properties are still not good enough to be used in the optical field. Furthermore, by operating in this way, the solubility of the peroxide in the polymerizable composition is significantly reduced.

The Applicant has now surprisingly found that it is possible to produce organic glass having good optical and physico-mechanical properties, starting from a polymerizable liquid solution in the presence of an amount of a polymerization initiator, stable at room temperature, which is significantly lower than that required for the polymerization of diethylene glycol bis(allyl carbonate) and than that which could be assumed on the basis of the density of the polymerizable double bonds of the composition itself.

In particular, it has been surprisingly found that the efficiency of said initiator in the liquid composition polymerization reaction of the present invention is much higher than that expected, and consequently an extremely reduced amount of said initiator is sufficient for allowing physico-mechanical properties to be reached which are appropriate for application in the optical field.

An object of the present invention therefore relates to a liquid solution which can undergo radicalic polymerization into organic glass, comprising the following components:

1) the product obtained from the transesterification of diallyl carbonate (A) with a mix of one or more linear or branched aliphatic diols (B), containing from 3 to 10 carbon atoms in the molecule, with a linear of branched aliphatic polyol (C) containing from 4 to 20 carbon atoms and from 3 to 6 hydroxyl groups in the molecule, said component 1) being present in an overall concentration ranging from 70 to 100% by weight with respect to the total weight of the mix of components 1) and 2);

2) one or more components of the acrylic, methacrylic, vinylic or allylic type or mixtures thereof, in an overall concentration ranging from 0 to 30% weight with respect to the total weight of the mix of components 1) and 2);

3) a polymerization initiator or a mix of two or more polymerization initiators, stable at room temperature, belonging to the class of peroxides, in an overall concentration ranging from 0.03 to 0.1 mole per 1 kg of final composition.

Component 1).

In component 1) of the liquid composition which can undergo radicalic polymerization into organic glass, object of the present invention, the molar ratio A/(B+C) ranges from 2/1 to 5/1 and the quantity of (C) in the mix (B+C) is equal to or lower than 25% weight with respect to the total of said mix (B+C).

Preferably, in component 1) of the liquid composition object of the present invention, the molar ratio A/(B+C) ranges from 2.5/1 to 4/1 and the amount of (C) in the mix (B+C) ranges from 5% weight to 20% weight with respect to the total of said mix (B+C).

Diols (B) which can be used for the purposes of the present invention, as already mentioned above, are linear or branched aliphatic diols, containing from 3 to 10 carbon atoms in the molecule.

Specific examples of diols (B) useful for the purposes of the present invention are: diethylene glycol, triethylene glycol, tetraethylene glycol, 1,4-butanediol, 1,6-hexanediol, 1,3-propanediol, neopentyl glycol, dipropylene glycol, 2,2,4-trimethyl-1,3-pentanediol, 1,4-cyclohexane dimethanol, etc.

Preferred diols for the purposes of the present invention are diethylene glycol and neopentyl glycol.

Polyols (C) useful for the purposes of the present invention are, as already mentioned, linear or branched aliphatic polyols containing from 4 to 20 carbon atoms and from 3 to 6 hydroxyl groups in the molecule.

Specific examples of polyols (C) which can be used for the purposes of the present invention are: pentaerythrite, trimethylol propane, dipentaerythrite, ditrimethylol propane, tris(hydroxy-ethyl) isocyanurate, etc . . .

Preferred polyols for the purposes of the present invention are: pentaerythrite and trimethylol propane.

Component 1) of the polymerizable liquid composition object of the present invention is obtained starting from diallyl carbonate (A) and from the mix (B+C) by operating under transesterification conditions.

In particular, the reagents are put in contact with each other, in the above-mentioned proportions, and reacted at temperatures ranging from 80 to 160° C., preferably from 90 to 130° C., in the presence of an alkaline-type catalyst, continuously eliminating the allyl alcohol which is formed as reaction by-product.

Alkaline catalysts which can be used for the purposes of the present invention are: hydroxides, carbonates and alcoholates of alkaline metals, organic bases and basic ion exchange resins.

Specific examples of alkaline-type catalysts useful for the purposes of the present invention are: sodium hydroxide, sodium carbonate, sodium methylate.

The catalyst is conveniently used in an amount equal to at least 1 ppm (parts per million in weight) with respect to the sum of the weights of components (B+C) and, preferably, in a quantity ranging from 0.01% to 0.3% by weight.

The above-mentioned transesterification reaction is suitably carried out at such a pressure as to bring the system to the boiling point at the selected operating temperature, in order to favour the elimination of allyl alcohol from the reaction mixture: for example, pressure values ranging from 60 mbar to 1030 mbar, preferably between 60 mbar and 500 mbar, are suitable for the purpose.

By operating under the above-mentioned conditions, the reaction times generally range from 0.5 hours to 20 hours, preferably from 0.5 to 3 hours.

After cooling, the above reaction mix is washed with water in order to remove the small amounts of residual catalyst and, after de-mixing and separation of the aqueous phase, the non-reacted diallyl carbonate is eliminated by distillation, by heating up to temperatures of around 130° C., under decreasing pressure, with final values of between 0.1 mbar and 20 mbar, preferably between 0.5 mbar and 2 mbar, obtaining the desired composition as residue. The composition thus obtained is filtered after possible treatment with activated carbon.

Component 1) of the polymerizable composition, object of the present invention, is liquid at room temperature and has viscosity values ranging from 15 cSt to 300 cSt and density values ranging from 1.1 g/ml to 1.3 g/ml. Component 1) of the polymerizable liquid composition, object of the present invention, is a complex mix which contains allyl carbonates of components (B) and (C), in monomeric and oligomeric form, as well as mixed oligomeric allyl carbonates of said components (B) and (C), the relative quantities of said constituents of component 1) of the polymerizable composition mainly depending on the selected ratios of the reagents (A), (B) and (C).

Component 2).

In the liquid composition which can undergo radicalic polymerization into organic glass, object of the present invention, component 2) consists of one or more co-monomers of the acrylic, methacrylic, vinylic or allylic type or mixtures thereof.

Non-limiting examples of co-monomers useful for the purposes of the present invention are: methyl methacrylate, vinyl acetate, vinyl esters of versatic acids 9 and 10 known on the market as VeoVa 9 and VeoVa 10, triallyl cyanurate, triallyl isocyanurate, diallyl maleate, diallyl fumarate, diallyl isophthalate, diallyl terephthalate, etc.

Said co-monomers are present in an overall concentration of between 0 and 30% by weight in the mix of components 1) and 2), preferably in a concentration of 1 to 20% by weight.

Component 3).

Component 3) of the liquid composition which can undergo radicalic polymerization into organic glass, object of the present invention, is a polymerization initiator or a mixture of two or more polymerization initiators stable at room temperature, belonging to the group of peroxides.

Peroxides stable at room temperature, which can be used for the purposes of the present invention, are those having a storage temperature not lower than +15° C.

Among the peroxides stable at room temperature mentioned above, the following are suitable for the purposes of the present invention: dialkyl peroxy dicarbonates such as di(4-t-butyl-cyclohexyl)peroxy dicarbonate and dimyristyl peroxy dicarbonate. The preferred is di(4-t-butyl-cyclohexyl)peroxy dicarbonate (BCHPC).

Diacyl peroxides useful for the purposes of the present invention are dibenzoyl peroxide, didecanoyl peroxide, dilauroyl peroxide. Among these, dibenzoyl peroxide is preferred.

Other stable peroxides at room temperature, useful for the purposes of the present invention are perketals, such as, for example, 1,1-di(t-butyl peroxy) cyclohexane, 1,1-di(t-butyl peroxy)3,3,5 trimethyl cyclohexane, 1,1-di(t-amyl peroxy)cyclohexane. Among these, 1,1-di(t-amyl peroxy)cyclohexane is preferred.

Said polymerization initiators can be used separately in polymerizable compositions containing Component 2), whereas, in polymerizable compositions not containing said Component 2), the peroxides belonging to the groups of diacyl peroxides and perketals, can be only used in combination with the above-mentioned dialkyl peroxy dicarbonates stable at room temperature.

Said polymerization initiators are present in a total concentration of between 0.03 and 0.1 moles per 1 kg of final composition.

The liquid polymerizable composition, object of the present invention, can optionally contain one or more conventional additives such as, for example, antioxidants, light stabilizers, lubricants, dyes, pigments, UV-absorbers, IR-absorbers, and similar, in a total amount in any case not higher than 1 part by weight for every 100 parts by weight of the compositions. Examples of additives useful for the purposes of the present invention are: sterically hindered phenols, sterically hindered amines, benzophenones, benzo triazoles, organic phosphites and phosphonites, etc.

The composition, object of the present invention, containing component 1), the polymerization initiator, possibly the co-monomer forming component 2) and possibly one or more additives selected from those mentioned above, is transformed into the relative organic glass by operating at a temperature ranging from 30 to 120° C., with polymerization times which can vary between 1 and 100 hours.

The organic glass thus obtained is particularly useful in the production of ophthalmic lenses, sun glasses, protective shields, display windows, manifolds and solar and photovoltaic panels, substrates for optical disks, display panels and video-terminals; said manufactured products being a further object of the present invention.

As mentioned above, the amount of polymerization initiator stable at room temperature of the liquid composition of the present invention is significantly lower than both the quantity required for the polymerization of diethylene glycol bis(allyl carbonate), and that which can be deduced on the basis of the polymerizable double bond density of the composition itself, a value which, as a first approximation, can be correlated to the percentage of shrinkage.

The organic glass obtained starting from the composition object of the present invention, has excellent optical and physico-mechanical properties, suitable for application in the optical field, and much better than the optical and physico-mechanical properties obtained, when possible, starting from compositions consisting of said peroxides stable at room temperature and diethylene glycol bis(allyl carbonate).

The properties of the organic glass thus obtained are also unexpectedly better than those obtained starting from monomers having a density of reactive double bonds, and therefore with shrinkage values similar to those of the compositions of the present invention.

Said properties and consequently the advantages of the composition according to the present invention, will appear evident from the following experimental comparative examples, which should in no way be considered as limiting the scope of the invention, in which the peroxide amount actually available in the polymerizable composition is expressed in molar terms to emphasize the importance of the invention.

Polymerizable liquid compositions were prepared in said examples, by reacting, under transesterification conditions, diallyl carbonate (A) with mixtures of compounds (B) and (C) as specified in the examples.

Some compositions also include the use of a co-monomer selected from those mentioned above as Component 2).

The polymerization initiator, or mix of polymerization initiators selected from those mentioned above as Component 3), are added to the liquid compositions thus obtained, in the amounts and proportions specified in the examples.

The compositions containing the polymerization initiator are transformed, by polymerization, into sheets and ophthalmic lenses, both neutral and/or corrective, by means of the technique known as “casting”. By operating according to said technique, the liquid compositions containing the polymerization initiator are poured into a mould consisting of two glass elements, with a spacing seal made of plasticized polyvinyl chloride, or ethylene vinyl acetate co-polymer (EVA), low density polyethylene (LDPE), or other suitable material, depending on the operating conditions.

The liquid compositions are then polymerized by means of thermal treatment in a forced air oven, with a gradual increase in the temperature, as indicated in the following experimental examples.

At the end of the above-mentioned treatment, the moulds are opened and the polymerized product is collected, which, at times, undergoes further thermal treatment at 120° C. in an oven (post-curing). The properties are tested on the products thus obtained; in particular, the following characteristics are determined on the flat sheets:

(a) Optical Characteristics

Refractive index (n^{D}₂₀): measured with an Abbe re-fractometer (ASTM D-542);

Yellow index (YI), (ASTM D-1925), determined by means of a Macbeth 1500 Plus spectrophotometer, defined as:
YI=100/Y (1.277 X-1.06 Z)
(b) Physico-Mechanical Characteristics

Density: determined by means of a hydrostatic balance at a temperature of 20° C. (ASTM D-792);

Polymerization shrinkage calculated by means of the following formula:
% Shrinkage=100·(polymer density−monomer density/polymer density)

Rockwell hardness (M) measured by means of a Rockwell durometer (ASTM D-785);

Izod unnotched shock resistance (ASTM D-256 modified);

Deflection temperature under stress 1.82 MPa (HDT) (ASTM D-648).

The following properties are determined on the neutral and corrective lenses:

(c) Dyeability

The capacity of the material to absorb a dye on its surface is determined by soaking a neutral lens in an aqueous bath in which the dye BPI grey is dispersed.

The lens is soaked, for the above purpose, in said colouring bath for 15-30 minutes at temperatures ranging from 80 to 85° C. and, after rinsing with demineralized water, the lens transmittance is determined by measuring the chromatic coordinate Y as described by CIE (1931) Standard Observer.

From the examples provided hereunder, it can be clearly seen that the compositions, object of present invention, containing stable peroxides at room temperature, allow organic glass to be obtained, having the same or improved characteristics with respect to the organic glass of the known art obtained from the polymerization of bis(allyl carbonate) of diethylene glycol and IPP peroxide.

It will also be demonstrated that with the monomers of the known art, even with those characterized by low polymerization shrinkage, it is not possible to obtain organic glass comparable with that of the present invention.

### EXAMPLE 1

The synthesis of a Component 1 according to the present invention, is described below.

The following products are charged into a three-necked jacketed flask, equipped with a thermometer and magnetic stirrer, surmounted by a distillation column with ten perforated plates of 30 mm in diameter:
pentaerythrite (PE): 80 g (0.59 moles);
diethylene glycol (DEG): 267 g (2.5 moles);
neopentyl glycol (NPG): 187 g (1.8 moles);
diallyl carbonate (DAC): 2173 g (15.3 moles);
20% weight solution of sodium methylate in methanol: 2.0 ml.

The reaction is carried out for three hours at a temperature of 85 to 120° C. and a decreasing pressure from 200 to 130 mbar, by distilling the allyl alcohol during its formation (total 749 ml; purity >99%).

After cooling, the reaction mixture is washed with two aliquots of 500 ml of demineralized water. The excess DAC is distilled at a pressure of about 1 mbar, by operating at an increasing temperature up to 130° C.: the product obtained is filtered through a membrane filter of 0.45 W.

967 g of a liquid product are obtained, having the following characteristics:
Viscosity (25° C.): 89 cSt;
Density (20° C.): 1.165 g/ml;
Refractive index n^{D}₂₀: 1.458;
Apha colour: 2.

The above product is a complex mix consisting of: monomer and oligomers of bis(allyl carbonate) of diethylene glycol, monomer and oligomers of bis(allyl carbonate) of neopentyl glycol, monomer and oligomers of tetrakis(allyl carbonate) of pentaerythrite, and mixed poly(allyl carbonates) of the above diols and polyol.

### EXAMPLE 2

The synthesis according to the present invention, of a further Component 1, is described.

The following products are charged into a three-necked jacketed flask, equipped with a thermometer and magnetic stirrer, surmounted by a distillation column with ten perforated plates of 30 mm in diameter:
pentaerythrite (PE): 34.5 g (0.25 moles);
diethylene glycol (DEG): 223 g (2.1 moles);
diallyl carbonate (DAC): 1000 g (7.04 moles);
20% weight solution of sodium methylate in methanol: 1.2 ml.

The reaction is carried out for three hours at a temperature of 83 to 120° C. and a decreasing pressure from 200 to 130 mbar, by distilling the allyl alcohol during its formation (total 346 ml; purity >99%).

After cooling, the reaction mixture is washed with two aliquots of 500 ml of demineralized water.

The excess DAC is distilled at a pressure of about 1 mbar, by operating at an increasing temperature up to 130° C.: the product obtained is filtered through a membrane filter of 0.45 μm.

525 g of a liquid product are obtained, having the following characteristics:
Viscosity (25° C.): 75 cSt;
Density (20° C.): 1.192 g/ml;
Refractive index n^{D}₂₀: 1.461;
Apha colour: 2.

The above product is a complex mix consisting of: monomer and oligomers of bis(allyl carbonate) of diethylene glycol, monomer and oligomers of tetrakis(allyl carbonate) of pentaerythrite, and mixed poly(allyl carbonates) of the above diol and polyol.

### EXAMPLE 3

The liquid compositions 1 and 2 are prepared, polymerizable into organic glass having good optical and physico-mechanical properties according to the present invention, consisting of the product of example 1 as component 1), VeoVa 9 as component 2), in the presence of the initiator di(4-t-butyl cyclohexyl)-peroxy-dicarbonate (BCHPC), in the ratios indicated in table 1. The product VeoVa 9 is a commercial product consisting of a mix of vinyl esters of versatic acid 9, commercialized by the company Resolution.

The compositions of the known art (A) based on bis(allyl carbonate) of diethylene glycol (BAC of DEG) and peroxide initiator IPP, and the composition (B) based on the product of example 2 of the present invention and the peroxide initiator CHPC, are also indicated in the same Table for comparative purposes.

TABLE 1

| | Composition | | | |
|---|---|---|---|---|
| | 1 | 2 | Comp. A | Comp. B |
| Product Example 1 | 85 | 80 | — | — |
| (weight %) | | | | |
| VeoVa 9 (% weight) | 15 | 20 | — | — |
| BCHPC (moles per 1 kg of | 0.075 | 0.075 | — | — |
| solution) | | | | |
| BAC of DEG (weight %) | — | — | 100 | — |
| Product Example 2 | — | — | — | 100 |
| (weight %) | | | | |
| Polymerization initiator | — | — | IPP | CHPC |
| (moles for 1 kg solution) | | | 0.146 | 0.175 |
| Apha colour | 2 | 2 | 1 | 2 |
| Viscosity (25° C., cSt) | 39 | 30 | 13.7 | 75 |
| Refractive index (n^{D}₂₀) | 1.455 | — | 1.452 | 1.461 |
| Density (20° C., g/ml) | 1.116 | 1.099 | 1.150 | 1.192 |

The above compositions are polymerized by means of thermal treatment in an oven with forced air circulation, with a gradual increase in the temperature from 40° C. to 80° C. in 20 hours and the characteristics specified in table 2 are determined on the organic glass thus obtained.

TABLE 2

| | Composition | | | |
|---|---|---|---|---|
| | 1 | 2 | Comp. A | Comp. B |
| Density (20° C., g/ml) | 1.238 | 1.220 | 1.311 | 1.328 |
| Shrinkage % | 9.9 | 9.9 | 12.1 | 10.2 |
| YI ^{(a)} | 1.04 | 0.96 | 1.5 | 1.6 |
| Rockwell hardness ^{(a)} | 101 | 101 | 100 | 100 |
| Izod shock resistance | 19.3 | 16.2 | 20 | 30 |
| (KJ/m²) | | | | |
| HDT (° C.) | 53 | 56 | 60 | 61 |
| n^{D}₂₀ | 1.494 | 1.489 | 1.499 | 1.500 |
| Dyeability | 33.4 | 33.8 | 35.9 | 42.9 |
| (15′ at 85° C.) | homogen. | homogen. | homogen. | homogen. |
| Y (lens colour) | | | | |

^{(a)} 2-hydroxy-4-methoxy benzophenone (0.1% weight) added.
Sheet thickness 5 mm.

From an examination of table 2, it is evident that the properties of compositions 1 and 2 of the present invention are similar or, in some cases, better than those of composition (A) and (B) of the known art, notwithstanding the concentration of peroxide in molar terms is only half.

In particular, composition 1, with the same hardness and dyeability values, which are fundamental properties in the optical field, has an extremely favourable YI value.

The high and surprising efficiency of the peroxide initiator is thus demonstrated in the composition of the present invention, with all the safety and economical advantages due to it higher stability.

### EXAMPLE 4

Table 3 also indicates, for comparative purposes, compositions (C) and (D) containing as components 1) BAC of DEG and a low shrinkage pre-polymer BAC of DEG, obtained by subjecting the monomer BAC of DEG, in the presence of 0.1% of 1,1-di(tert.butyl peroxy)-3,3,5-trimethyl cyclohexane, to controlled polymerization at a temperature of 95° C., until a viscosity equal to about 150 cSt is obtained.

VeoVa 9 and the peroxide initiator BCHPC are added to these compositions, in the proportions specified, as component 2) and 3) of the present invention, respectively.

The above compositions are subjected to polymerization by means of thermal treatment, as in the previous example, and the characteristics shown in Table 3 are determined on the organic glass thus obtained.

TABLE 3

| | Composition | |
|---|---|---|
| | Comparative | Comparative |
| | (C) | (D) |
| BAC of DEG monomer (% weight) | 85 | — |
| BAC of DEG pre-polymer (% weight) | — | 85 |
| VeoVa 9 (% weight) | 15 | 15 |
| BCHPC (moles per 1 kg solution) | 0.075 | 0.075 |
| Density (20° C., g/ml) | 1.243 | 1.254 |
| Shrinkage % | 11.6 | 10.4 |
| YI ^{(a)} | 0.78 | 0.80 |
| Rockwell hardness ^{(a)} | 54 | 61 |
| HDT (° C.) | <35 | 36 |
| n^{D}₂₀ | 1.495 | 1.493 |
| Dyeability (15′ at 85° C.) | 6.3 | not estimable |
| Y (lens colour) | heterogeneous | heterogeneous |

^{(a)} 2-hydroxy-4-methoxy benzophenone (0.1% weight) added.
Sheet thickness 5 mm.

The above table clearly shows that the organic glass obtained starting from the products of the known art BAC of DEG monomer and pre-polymer and the peroxide initiator BCHPC, also in the presence of VeoVa 9, does not have useful properties for the purposes of the present invention.

In particular, what is mentioned above, is demonstrated i.e. that the composition of the known art, characterized by a shrinkage value, and therefore density of reactive double bonds similar to those of compositions 1) and 2) of the present invention, does not allow organic glass having suitable properties for application in the optical field, to be obtained.

### EXAMPLE 5

The liquid polymerizable compositions 3, 4, 5, and 6, are prepared according to the present invention, consisting of the product of example 1, vinyl acetate (VA) or methyl methacrylate (MMA) and peroxide initiator BCHPC, in the ratios indicated in Table 4.

The composition (E) based on BAC of DEG, VA and BCHPC is also indicated in the same Table for comparative purposes.

The above compositions are polymerized as described in the previous example and the characteristics listed in Table 4 are determined on the organic glass thus obtained.

TABLE 4

| | Composition | | | | |
|---|---|---|---|---|---|
| | 3 | 4 | 5 | 6 | Comp. E |
| Product | 90 | 90 | 90 | 90 | — |
| Exam. 1 (% w) | | | | | |
| VA (% w) | 10 | 10 | 10 | — | 10 |
| MMA (% w) | — | — | — | 10 | — |
| BCHPC moles per | 0.053 | 0.058 | 0.063 | 0.063 | 0.063 |
| 1 kg of solution | | | | | |
| BAC of DEG (% w) | — | — | — | — | 90 |
| Density | 1.285 | 1.286 | 1.286 | 1.277 | — |
| (20° C., g/ml) | | | | | |
| Shrinkage % | 11.5 | 11.6 | 11.6 | 11.0 | — |
| YI ^{(a)} | 0.94 | 1.01 | 1.03 | 0.98 | 0.76 |
| Rockwell | 104 | 106 | 106 | 100 | 71 |
| hardness ^{(a)} | | | | | |
| n^{D}₂₀ | 1.494 | 1.494 | 1.494 | 1.496 | 1.497 |
| Dyeability | 24.7 | 31.8 | 35.7 | 26.0 | 5.4 |
| (15′ at 85° C.), | homog. | homog. | homog. | homog. | heterog. |
| Y (lens colour) | | | | | |

^{(a)} 2-hydroxy-4-methoxy benzophenone (0.1% weight) added.
Sheet thickness 5 mm.

The high efficiency of the peroxide catalyst is confirmed by the above data, in the compositions of the present invention, and this allows, organic glass having excellent optical and physico-mechanical properties to be obtained even with very low concentrations.

### EXAMPLE 6

The liquid polymerizable compositions 7 and 8 are prepared according to the present invention, consisting of the product of example 1, VeoVa 9 and mixtures of peroxide initiators BCHPC and 1,1-di(t-amyl peroxy)cyclohexane (TAPC), in the ratios indicated in Table 5.

Neutral lenses having a thickness of 2.4 mm and semi-finished lenses are prepared with the above compositions by means of polymerization in a water bath, and the characteristics indicated in table 5 are determined on the lenses thus obtained.

TABLE 5

| | | Composition | | | |
|---|---|---|---|---|---|
| | | 7 | | 8 | |
| Product Ex. 1 (% weight) | | 85 | | 85 | |
| VeoVa 9 (% weight) | | 15 | | 15 | |
| BCHPC (moles per 1 kg solution) | | 0.05 | | 0.05 | |
| TAPC (pure, moles per 1 kg solution) | | 0.01 | | 0.009 | |
| Polymerization cycle | | 45-95° C. in 20 hours | | 48-97° C. in 20 hours | |
| Polymerized products | | neutral lens | semi-finish. | neutral lens | semi-finish. |
| | | 2.4 mm | 16 mm | 2.4 mm | 10 mm |
| Rockwell | as such | 93 | 100 | 91 | 97 |
| hardness ^{(a)} | post-curing | 96 | 105 | 94 | 104 |
| | 2 hrs 110° C. | | | | |

| | | | | |
|---|---|---|---|---|
| Dyeability (15′ at 85° C.) | 35.6 | — | 30.5 | — |
| Y (lens colour) | homogen. | | homogen. | |

^{(a)} 2-hydroxy-4-methoxy benzophenone (0.1% weight) added.
Sheet thickness 5 mm.

### EXAMPLE 7

The liquid polymerizable compositions 9, 10 and 11 are prepared according to the present invention, consisting of the product of example 2, VeoVa 9 and the peroxide initiator BPO in the ratios indicated in Table 6.

An analogous composition of the known art is prepared for comparative purposes (Comparative (F)), based on BAC of DEG and the peroxide initiator BPO.

Flat sheets are prepared using the above compositions, having a thickness of 5 mm, and also 2.4 mm thick neutral lenses, by means of polymerization in a water bath at a temperature ranging from 55° C. to 90° C. over a period of 21 hours and the characteristics indicated in Table 6 are determined on the organic glass thus obtained.

TABLE 6

| | | Composition | | | |
|---|---|---|---|---|---|
| | | 9 | 10 | 11 | Compar. F |
| Product Ex. 2 (% weight) | | 98 | 90 | 80 | — |
| VeoVa 9 (% weight) | | 5 | 10 | 20 | — |
| BAC of DEG (% weight) | | — | — | — | 100 |
| BPO (pure, moles per 1 kg solution) | | 0.065 | 0.050 | 0.050 | 0.104 |
| YI ^{(a)} | as such | 1.23 | 1.00 | 0.81 | 2.80 |
| | post-curing | 1.62 | 1.31 | 1.24 | 4.12 |
| | 2 hrs 110° C. | | | | |
| Rockwell | as such | 96 | 99 | 97 | 101 |
| Hardness ^{(a)} | post-curing | 99 | 101 | 98 | 99 |
| | 2 hrs 110° C. | | | | |

| | | | | |
|---|---|---|---|---|
| Dyeability (30′ at 80° C.) | 34.6 | 30.6 | 35.5 | 35.0 |
| Y (lens colour) | homogen. | homogen. | homogen. | homog. |

^{(a)} 2-hydroxy-4-methoxy benzophenone (0.1% weight) added.
Sheet thickness 5 mm.

The UV radiation resistance is also determined on composition nr. 9 of the present invention, after adding 0.05% by weight of 2-hydroxy-4-methoxy-benzophenone, by the outdoor exposure of 5 mm thick sheets.

The aging of the polymerized products is evaluated by measuring the YI after prefixed intervals of exposure times.

The results are shown in Table 7 compared with compositions of the known art.

TABLE 7

| | Composition | | |
|---|---|---|---|
| Exposure time | 9 | Compar. F | Compar. A |
| (hours) | YI | YI | YI |
| 0 | 1.42 | 2.58 | 1.40 |
| 3 | 1.40 | 3.49 | 1.41 |
| 7 | 1.40 | 4.12 | 1.40 |
| 14 | 1.44 | 5.13 | 1.44 |
| 21 | 1.47 | 7.35 | 1.43 |
| 50 | 1.52 | 9.24 | 1.44 |

An examination of the data of Tables 6 and 7, shows that the polymerized products of composition 9, object of the present invention, obtained with reduced amounts of the initiator BPO, have much better YI and UV resistance values with respect to composition (F) of the known art and similar to those of the comparative composition (A) of the known art containing the IPP peroxide initiator, thus allowing its use in the optical field.

### EXAMPLE 8

The liquid polymerizable compositions 12 and 13 are prepared according to the present invention, consisting of the product of example 1, VeoVa 10 and the peroxide initiator BPO in the ratio indicated in Table 8.

An analogous composition is prepared for comparative purposes (Comparative (G)), based on the product of Example 1 and the peroxide initiator BPO, without Component 2) of the present invention.

Flat sheets are prepared using the above compositions, having a thickness of 5 mm and 3 mm, and also 2.4 mm thick neutral lenses, by means of polymerization in a water bath with a gradual increase of the temperature from 55° C. to 90° C. over a period of 21 hours and the characteristics indicated in Table 8 are determined on the organic glass thus obtained.

TABLE 8

| | Composition | | |
|---|---|---|---|
| | 12 | 13 | Comp. G |
| Product Example 1 (weight %) | 90 | 70 | 100 |
| VeoVa 10 (% weight) | 10 | 30 | — |
| pure BPO | 0.050 | 0.050 | 0.050 |
| (moles per 1 kg of solution) | | | |
| Density (20° C., g/ml) | 1.257 | 1.190 | 1.288 |
| Shrinkage % | 10.7 | 11.2 | 9.6 |
| YI ^{(a)} | 1.20 | 0.97 | 2.11 |
| Rockwell Hardness ^{(a)} | 99 | 90 | 78 |
| Izod shock resistance (KJ/m²) | 15.6 | 10.2 | 12.3 |
| HDT (° C.) | 56 | 50 | 50 |
| N^{D}₂₀ | 1.496 | 1.493 | 1.499 |

^{(a)} 2-hydroxy-4-methoxy benzophenone (0.1% weight) added.
Sheet thickness 5 mm.

An examination of the data of Table 8 shows the good properties of the compositions of the present invention with respect to the composition without Component 2).

In particular, the YI value is extremely favourable.

1. A liquid composition which can undergo radicalic polymerization into organic glass comprising the following components:
1) the product obtained from the transesterification of diallyl carbonate (A) with a blend of one or more linear or branched aliphatic diols (B), containing from three to ten carbon atoms in the molecule, with a linear or branched aliphatic polyol (C), containing from four to twenty carbon atoms and from three to six hydroxyl groups in the molecule; said component 1) being present in an overall concentration ranging from. 70 to 100% by weight with respect to the total weight of the mixture of components 1) and 2);
2) one or more co-monomers of the acrylic, methacrylic, vinylic or allylic type and mixtures thereof, in an overall concentration ranging from 0 to 30% weight with respect to the total weight of the mixture of components 1) and 2);
3) a polymerization initiator or a mixture of two or more polymerization initiators, stable at room temperature, belonging to the group of peroxides, in an overall concentration ranging from 0.03 to 0.1 moles per 1 kg of final composition.

2. The composition according to claim 1, characterized in that the molar ratio A/(B+C) ranges from 2/1 to 5/1 and the amount of (C) in the mixture (B+C) is equal to or lower than 25% by weight on the total of said mixture (B+C).

3. The composition according to claim 1, characterized in that the molar ratio A/(B+C) ranges from 2.5/1 to 4/1 and the amount of (C) in the mixture (B+C) ranges from 5% weight to 20% by weight on the total weight of said mixture (B+C).

4. The composition according to claim 1, characterized in that the diols (B) are diethylene glycol, triethylene glycol, tetraethylene glycol, 1,4-butanediol, 1,6-hexanediol, 1,3-propanediol, neopentyl glycol, dipropylene glycol, 2,2,4-trimethyl-1,3-pentanediol, 1,4-cyclohexane dimethanol.

5. The composition according to claim 4, characterized in that the diols are diethylene glycol and neopentyl glycol.

6. The composition according to claim 1, characterized in that the polyols (C) are pentaerythrite, trimethylol propane, dipentaerythrite, di-trimethylol propane, tris(hydroxy-ethyl)isocyanurate.

7. The composition according to claim 6, characterized in that the polyols (C) are pentaerythrite, trimethylol propane.

8. The composition according to any of the previous claims, characterized in that component 1) is obtained starting from diallyl carbonate (A) and the mixture (B+C), operating under transesterification conditions, at a temperature ranging from 80 to 160° C., in the presence of an alkaline-type catalyst, continuously eliminating the allyl alcohol which is formed as reaction by-product.

9. The composition according to claim 8, characterized in that the transesterification is carried out at a temperature ranging from 90 to 130° C. and the alkaline catalyst is selected from hydroxides, carbonates and alcoholates of alkaline metals, organic bases, basic ion exchange resins.

10. The composition according to claim 9, characterized in that the catalyst is selected from sodium hydroxide, sodium carbonate, sodium methylate.

11. The composition according to any of the previous claims from 8 to 10, characterized in that the catalyst is used in an amount at least equal to 1 ppm (parts per million by weight) with respect to the sum of the weights of components (B+C).

12. The composition according to claim 11, characterized in that the catalyst is used in amounts ranging from 0.01% to 0.3% weight.

13. The composition according to any of the previous claims from 8 to 12, characterized in that the transesterification reaction is carried out at pressure values ranging from 60 mbar to 1030 mbar and for reaction times of between 0.5 and 20 hours.

14. The composition according to claim 13, characterized in that the transesterification reaction is carried out at pressure values ranging from 60 to 500 mbar.

15. The composition according to claim 13, characterized in that the transesterification reaction is carried out with reaction times ranging from 0.5 to 3 hours.

16. The composition according to claim 1, characterized in that component 2) is selected from methyl methacrylate, vinyl acetate, vinyl esters of versatic acids 9 and 10 known on the market as VeoVa 9 and VeoVa 10, triallyl cyanurate, triallyl isocyanurate, diallyl maleate, diallyl fumarate, diallyl isophthalate, diallyl terephthalate and mixtures thereof.

17. The composition according to claim 1, characterized in that component 2) is present in an overall concentration ranging from 1 to 20% weight in the mixture of Components 1) and 2).

18. The composition according to claim 1, characterized in that component 3) is selected from peroxides having a storage temperature not lower than +15° C.

19. The composition according to claim 1, characterized in that the peroxides are selected from dialkyl-peroxy-dicarbonates, diacyl-peroxides and/or perketals.

20. The composition according to claim 19, characterized in that the dialkyl-peroxy-dicarbonates are di(4-t-butyl-cyclohexyl)peroxy-dicarbonate and dimyristyl-peroxy-dicarbonate.

21. The composition according to claim 19, characterized in that the dialkyl-peroxy-dicarbonate is di(4-t-butyl-cyclohexyl)peroxy-dicarbonate (BCHPC).

22. The composition according to claim 19, characterized in that the diacyl-peroxides are dibenzoyl-peroxide, didecanoyl peroxide and dilauroyl peroxide.

23. The composition according to claim 19, characterized in that the diacyl-peroxide is dibenzoyl-peroxide.

24. The composition according to claim 19, characterized in that the perketals are 1,1-di(t-butyl peroxy)cyclohexane, 1,1-di(t-butyl peroxy)3,3,5 trimethyl cyclohexane, 1,1-di(t-amyl peroxy)cyclohexane.

25. The composition according to claim 19, characterized in that the perketal is 1,1-di(t-amyl peroxy)cyclohexane.

26. The composition according to claim 1, characterized in that, when component 2) is absent, the diacyl peroxides and/or perketals are used in combination with dialkyl peroxy dicarbonates.

27. The composition according to any of the previous claims, characterized in that it contains one or more conventional additives, such as antioxidants, light stabilizers, lubricants, dyes, pigments, UV-absorbers, IR-absorbers, and similar, in a total amount in any case not higher than 1 part by weight for every 100 parts by weight of the compositions.

28. The composition according to any of the previous claims, characterized in that it is transformed into the relevant organic glass by operating at a temperature ranging from 30 to 120° C., with polymerization times varying from 1 hour to 100 hours.

29. Organic glass obtainable by the polymerization of a composition according to any of the previous claims.

30. Ophthalmic lenses, sun glasses, protective shields, display windows, manifolds and solar and photovoltaic panels, substrates for optical disks, display panels and video-terminals which can be obtained by the processing of the organic glass according claim 29.
